(19) United States
(12) Patent Application Publication
(10) Pub. No.: US 2009/0109929 A1
(43) Pub. Date: Apr. 30, 2009

(54) MEDIA ACCESS METHOD PERFORMED BY READER IN DENSE READER ENVIRONMENT

(75) Inventors: Cheng Hao QUAN, Daejeon-city (KR); Hee Sook MO, Daejeon-city (KR); Donghan LEE, Daejeon-city (KR); Ji Hoon BAE, Daejeon-city (KR); Gil Young CHOI, Daejeon-city (KR); Cheol Sig PYO, Daejeon-city (KR); Jong Suk CHAE, Daejeon-city (KR)

Correspondence Address: CANTOR COLBURN, LLP, 20 Church Street, 22nd Floor, Hartford, CT, 06103, US

(73) Assignee: Electronics and Telecommunications Research Institute, Daejeon-city (KR)

(21) Appl. No.: 12/190,990

(22) Filed: Aug. 13, 2008

(30) Foreign Application Priority Data
Oct. 29, 2007 (KR) 10-2007-0109113
May 22, 2008 (KR) 10-2008-0047739

(51) Int. Cl. H04Q 7/36

(52) U.S. Cl. 370/332

(57) ABSTRACT

Provided are a media access method and a reader for performing the media access method in a dense reader environment. The media access method divides an air time between the reader and a tag into a plurality of time slots, and operates in each of the plurality of time slots by using a listen before talking (LBT) technique. The plurality of time slots form a frame. Thus, the media access method can control the reader by performing channel scheduling between each of a plurality of readers and can efficiently recognize tags.

### CROSS-REFERENCE TO RELATED PATENT APPLICATION

This application claims the benefit of Korean Patent Application Nos. 10-2007-0109113, filed on Oct. 29, 2007, and 10-2008-0047739, filed on May 22, 2008 in the Korean Intellectual Property Office, the disclosures of which are incorporated herein their entirety by reference.

### BACKGROUND OF THE INVENTION

1. Field of the Invention

The present invention relates to a media access method performed by a reader in a dense reader environment, and more particularly, to a media access method which aims to effectively solve problems that occur when a plurality of readers competitively use a limited media (a wireless channel) source.

The present invention is supported by the ‘Information Technology (IT) Research and Development Program’ of the Ministry of Information and Communications (MIC) and the Institute for Information Technology Advancement (IITA) [2006-S-023-02, Development of Advanced RFID) System Technology].

2. Description of the Related Art

A conventional technology related to the present invention is classified into a media access technologies based on a frequency hopping (FH) technique and a listen before talking (LBT) technique. When a request for channel occurs, the FH technique randomly selects a frequency, uses the frequency for a maximum of 400 milliseconds (ms), and then hops to another frequency, whereas the LBT technique senses a status of a media before occupying the media, and uses the media for a maximum of 4 seconds when the media is idle.

The FH technique is mainly used in the United States of America (U.S.A.) where a wide bandwidth (902 megahertz (MHz)˜928 MHz) and a plurality of channels are used, and the LBT technique is mainly used in Europe where a narrow bandwidth (865 MHz˜868 MHz) and a small number of channels are used. Korea uses a 5.5 MHz (908.5 MHz˜915 MHz) bandwidth and a small number of channels (27 channels are defined with respect to 200 KHz) but both the FH technique and the LBT technique are allowed.

In a dense reader environment (hereinafter, a dense reader environment is an area where a plurality of readers operate in proximity of one another), since the number of readers simultaneously attempting to occupy media is greater than the number of channels, it is preferable to use the LBT technique rather than to use the FH technique. Also, in a dense reader environment, channel scheduling, that is, impartial channel allocation for providing a stable service, may be more important than channel allocation.

An air protocol, which is between a reader and a tag in an ultra high frequency (UHF) band and which is in the limelight of the distribution industry, tends to be unified to ISO/IEC 180006C (also, called ‘Gen2’). However, use of a radio wave source is set to follow technology standards of each country.

A media access method defined in the technology standard only provides a basic scheme. Thus, in the dense reader environment, if there is no channel scheduling between each of a plurality of readers, it takes long time to sense an idle channel even though the LBT technique is used. In the case where a channel occupancy time of each reader varies, problems occur since each reader has to wait for several seconds to use a channel for only a few ms. Also, in the dense reader environment, interference between each of a plurality of same channels, or between each of a plurality of adjacent channels has to be considered. The LBT technique, which first performs channel sensing to occupy a channel, does not interfere with communication of another reader, unlike the FH technique which hops between frequencies and uses a channel, regardless of whether another reader uses the channel. However, in order to solve the aforementioned problems, an improved media access method is required to efficiently control a plurality of readers, considering required reader characteristics such as a mean channel occupancy time and an acceptable maximum wait time, reader topology, an ambient radio environment, and the like.

TABLE 1
Wait time

| | | | |
|---|---|---|---|
| Minimum(s) | 0.015000 | Mean(s) | 2.446986 |
| Maximum(s) | 21.465000 | Variance(s) | 5.530443 |
| Range(s) | 21.450000 | Standard deviation(s) | 2.351689 |
| Observations | 10,000 | Coefficient of variation | 0.961055 |

| lower | fre- | | cumulative | |
|---|---|---|---|---|
| limit(s) | quency | proportion | proportion | histogram |
| 0.00000 | 1401 | 0.140100 | 0.140100 | ************** |
| 0.40000 | 1156 | 0.115600 | 0.255700 | *********** |
| 0.80000 | 1233 | 0.123300 | 0.379000 | ************ |
| 1.20000 | 832 | 0.083200 | 0.462200 | ******** |
| 1.60000 | 923 | 0.092300 | 0.554500 | ********* |
| 2.00000 | 612 | 0.061200 | 0.615700 | ****** |
| 2.40000 | 630 | 0.063000 | 0.678700 | ****** |
| 2.80000 | 428 | 0.042800 | 0.721500 | **** |
| 3.20000 | 460 | 0.046000 | 0.767500 | ***** |
| 3.60000 | 309 | 0.030900 | 0.798400 | *** |
| >=4.00000 | 2016 | 0.201600 | 1.000000 | ******************** |

Table 1 indicates a wait time when a total of 40 readers competitively use a total of 10 channels by using the conventional LBT technique. In a simulation, it is assumed that each of the 40 readers has an 800 ms channel occupancy time and is hopped to another channel when a channel is busy, according to a result of channel sensing. Referring to Table 1, it is possible to understand that a mean wait time is 2.4 seconds but a certain reader even waits for a maximum of 21 seconds. Also, it is possible to understand that a request from readers, which have a wait time greater than 4 seconds to occupy a channel, occupies more than 20% of a total request. In other words, it is clear that separate channel scheduling is required in a dense reader environment even though the LBT technique is used.

### SUMMARY OF THE INVENTION

In the case of a dense reader environment in which the number of readers simultaneously attempting to operate is greater than the number of available channels, due to problems caused by interference from same/adjacent channels, by collision between each of the same channels, by competitive use of limited channel sources, and the like, a tag recognition rate is lowered, a wait time (a response time) for channel occupancy increases, and the number of readers enabled to simultaneously operate (that is, the throughput) is limited.

In order to solve the aforementioned problems, the present invention provides a method of controlling readers by performing channel scheduling between each of a plurality of readers, and efficiently recognizing tags.

According to an aspect of the present invention, there is provided a media access method performed by a reader in a dense reader environment, the media access method including the operations of dividing an air time of a channel, which is shared by a plurality of readers, into a plurality of slots; and occupying the channel after performing channel sensing in each of the plurality of slots, wherein the plurality of slots form a frame having a predetermined size.

The media access method may further include the operations of transmitting a frame synchronization (FS) signal and occupying a channel in a first slot of the frame, wherein the transmitting and occupying are performed by a reader which is from among the plurality of readers that selected a same channel, which first senses that the channel is idle, and which becomes a channel mediator of the channel; and occupying the channel sequentially from a second slot, wherein the occupying is performed by the rest of the plurality of readers which receive a slot synchronization (SS) signal and which perform the channel sensing.

The media access method may include the operations of selecting a new channel having extra slots, wherein the selecting is performed by a reader which is from among the plurality of readers and which fails to occupy the channel in a slot in the frame; and receiving an SS signal in the new channel and occupying the new channel by performing the channel sensing.

The FS signal and the SS signal may have a specific pattern via ON/OFF of a radio frequency (RF) signal, and the plurality of readers may detect the specific pattern based on a received signal strength indication (RSSI) value so as to distinguish the FS signal from the SS signal.

The FS signal and the SS signal may comprise information having 1 bit or more.

According to another aspect of the present invention, there is provided a media access method performed by a reader in a dense reader environment, the media access method including the operations of selecting a channel according to a tag data access request; dividing an air time into a plurality of slots in the selected channel, and sensing a channel in a unit of a slot; and communicating with a tag according to a predetermined procedure, based on a result of the sensing.

According to another aspect of the present invention, there is provided a media access method performed by a reader in a dense reader environment, the media access method including the operations of dividing a zone, where a plurality of readers exist, into a plurality of sections; selecting a channel allocated to a section to which a reader belongs, from among the plurality of sections, and communicating with a tag after performing channel sensing; and, when a reader from among the plurality of readers does not belong to any one of the plurality of sections, selecting a channel allocated to a section most adjacent to the reader and communicating with a tag after performing channel sensing.

According to another aspect of the present invention, there is provided a reader that accesses media in a dense reader environment, the reader including a channel selecting unit selecting a channel according to a tag data access request; a channel sensing unit dividing an air time into a plurality of slots and sensing a channel in a unit of a slot in the selected channel in which the plurality of slots form a frame; and a communicating unit communicating with a tag according to a predetermined procedure, based on a result of the sensing.

According to another aspect of the present invention, there is provided a computer readable recording medium having recorded thereon a program for executing the media access method performed by the reader in the dense reader environment, on a computer.

### BRIEF DESCRIPTION OF THE DRAWINGS

The above and other features and advantages of the present invention will become more apparent by describing in detail exemplary embodiments thereof with reference to the attached drawings in which:

FIG. 1 is an operation state transition diagram of a reader according to an embodiment of the present invention;

FIG. 2 is a diagram of a frame structure when a plurality of readers, which share a specific channel, use a channel according to another embodiment of the present invention;

FIG. 3 is a diagram of a frame structure when only a channel mediator, which first occupies a specific channel, uses a channel according to another embodiment of the present invention;

FIG. 4 is a diagram of a structure of a synchronization signal according to another embodiment of the present invention;

FIG. 5 is a diagram for illustrating channel scheduling according to another embodiment of the present invention;

FIG. 6 is a diagram for describing a channel allocation method, according to an embodiment of the present invention;

FIG. 7 is a diagram for describing a channel allocation method, according to another embodiment of the present invention;

FIG. 8 is a flowchart of a media access method performed by a reader in a dense reader environment, according to another embodiment of the present invention; and

FIG. 9 is a block diagram of an internal structure of a reader that operates based on a slotted-listen before talking (LBT) technique according to another embodiment of the present invention.

### DETAILED DESCRIPTION OF THE INVENTION

The present invention will now be described more fully with reference to the accompanying drawings, in which exemplary embodiments of the invention are shown. Like reference numerals in the drawings denote like elements. In the following description, well-known functions or constructions are not described in detail since they would obscure the invention with unnecessary detail.

Also, when a part “includes” or “comprises” an element, unless there is a particular description contrary thereto, the part can further include other elements, not excluding the other elements.

In the present invention, a reader divides an air time (hereinafter, air time indicates a time period during which a reader and a tag communicate with each other) into a plurality of slots, and operates in each slot according to a listen before talking (LBT) technique. The plurality of slots form a frame. Synchronization between each of a plurality of readers is performed by a reader synchronization signal that includes a frame synchronization (FS) signal and a slot synchronization (SS) signal. The reader synchronization signal is implemented to be distinguished by a specific pattern of received signal strength indication (RSSI) values which are obtained via channel sensing by using the LBT technique. Such a technique proposed in the present invention is called a slotted-LBT technique.

That is, the present invention divides the air time into the plurality of slots to form the frame, and performs the synchronization between each of the plurality of readers by using a synchronization signal having a specific RSSI pattern that is distinguished according to a channel sensing function provided by the conventional LBT technique.

The synchronization signal is used not only to provide physical position (distance) information, an interference degree, or to synchronize each of the readers, but also has information about a frame or channel status, for example, information about whether the frame has extra slots, information about a distribution of a mean channel occupancy time of the readers using a corresponding channel, information about when channel occupancy is to be attempted, and the like. By doing so, the synchronization signal may efficiently control the plurality of readers.

Thus, the present invention may be applied to various radio frequency identification (RFID) applications, without modifying an air protocol between a reader and a tag, without separately adding devices, and without a separate frequency source allocation. Also, the present invention has no limit in terms of the number of acceptable readers, and may guarantee a stable wait time having a relatively low distribution. The present invention may control each of a plurality of channels, thus, the present invention may set the readers to use different channels according to a channel occupancy time of each reader. For example, the present invention may enable a reader having a 100 milliseconds (ms) channel occupancy time and a reader having an 800 ms channel occupancy time to use different channels, thereby reducing a channel wait time.

Also, the present invention may allocate the channels according to an application and a request so as to control the channels, may prevent the same channels from colliding with each other, and may minimize interference from the same/adjacent channels. The present invention uses the benefits of the conventional LBT technique, and performs the synchronization between each of the readers by using the RSSI pattern, thereby efficiently controlling the readers.

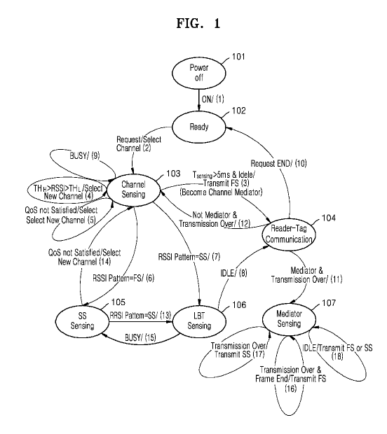

FIG. 1 is an operation state transition diagram of a reader according to an embodiment of the present invention.

Referring to FIG. 1, the reader operates based on the slotted-LBT technique by which the reader divides an air time of a channel into a plurality of time slots and occupies the channel by operating in each of the time slots according to the LBT technique.

First, when power is applied (1) to the reader, the reader switches from a power off status (101) to a ready status (102).

In the ready status (102), if a tag data access request occurs, the reader selects (2) a channel from among a plurality of available channels in order to occupy a channel, and switches to a channel sensing status (103). Here, various methods may be applied to the channel selection. For example, the method may comprise randomly selecting a channel from among the plurality of available channels, searching for a channel from among previously determined preferred channels, and the like. However, the present invention is not limited thereto, and various methods in the art may be employed and applied to the present invention. The reader that senses a corresponding channel operates as follows, according to a result of the sensing.

First, when the corresponding channel is idle (is in an idle status) for a long enough time (e.g., for more than 5 ms), the reader transmits the FS signal to the corresponding channel, simultaneously becomes (3) a channel mediator that is a mediating reader of the corresponding channel, and switches to a reader-tag communication status (104).

Second, when it is difficult to determine whether the corresponding channel is idle or busy according to an RSSI value of a received signal, (for example, when the RSSI value is included in a threshold range between an upper threshold value and a lower threshold value, that is, TH_{H}>RSSI>TH_{L}, the reader selects (4) a new channel, maintains the channel sensing status (103) in the selected new channel, and re-starts the channel sensing. Here, in order to select the new channel, a method of selecting a preferred channel according to a channel separation degree, a channel physical position, and the like may be used as well as the aforementioned various channel selection methods. An adjacent channel interference or an adjacent reader interference is the main reason when the RSSI value is included in the threshold range.

Third, when a user is not satisfied with a predetermined quality of service (QoS), that is, when a response time or a wait time exceeds a predetermined value, the reader selects (5) a new channel, maintains the channel sensing status (103) in the selected new channel, and re-starts the channel sensing. Here, in order to select the new channel, a method of selecting a preferred channel according to a response time may be used as well as the aforementioned various channel selection methods.

It is determined whether to constantly perform the channel sensing in a current channel or to attempt to hop to a new channel, according to a channel occupancy time, a frame size, the number of received requests, an acceptable wait time, the number of service, and the like.

Fourth, when the corresponding channel is busy and an FS signal having a specific RSSI pattern is sensed (6), that is, when another reader has already become a channel mediator of the corresponding channel, the reader switches to an SS signal sensing status (105), and constantly performs the channel sensing until an SS signal is sensed.

Fifth, when the corresponding channel is busy and an SS signal having a specific RSSI pattern is sensed (7), the reader switches to an LBT sensing status (106) and competes with other readers by using the LBT technique to occupy a channel. A reader, which has succeeded (8) in the channel competition, switches to the reader-tag communication status (104).

Sixth, when the corresponding channel is busy (9), the reader in the channel sensing status (103) constantly senses a channel.

The reader in the reader-tag communication status (104) may perform a tag inventory or may access a tag memory, with a tag by using an air protocol. After the reader ends communication with the tag, the reader operates as described below, according to a status of the reader.

First, when a request is ended, the reader switches (10) to the ready status (102).

Second, when the reader, which has ended the communication, is the channel mediator (11), the reader switches to a mediator sensing status (107) in order to perform a role as the channel mediator.

Third, when the reader, which has ended the communication, is not the channel mediator and attempts to constantly occupy a channel (12), the reader switches to the channel sensing status (103) and repeats the aforementioned procedures.

Meanwhile, the reader in the SS signal sensing status (105) switches to the LBT sensing status (106) when the SS signal having the specific RSSI pattern is sensed (13), and competes with other readers by using the LBT technique to occupy a channel. A reader, which has succeeded (8) in the channel competition, switches to the reader-tag communication status (104). Otherwise, when the reader in the SS signal sensing status (105) does not satisfy the QoS predetermined by the user, for example, when the response time or the wait time exceeds the predetermined value, the reader selects (14) a new channel and switches to the channel sensing status (103) in the selected new channel to re-start sensing of the selected new channel.

The reader in the LBT sensing status (106) competes with other readers according to the LBT technique to occupy a channel, and a reader, which has succeeded (8) in the channel competition, switches to the reader-tag communication status (104). A reader, which has failed (15) in the channel competition, switches to the SS signal sensing status (105) and continuously performs the channel sensing until a next SS signal is sensed.

The reader in the mediator sensing status (107) acts as the channel mediator, constantly senses a channel, and performs the following operations.

First, when a frame is ended, the channel mediator transmits (16) an FS signal to start a new frame. In general, a frame size is related to an acceptable maximum wait time (or, a response time), and may be appropriately set according to applications. For example, the frame size may be set to 500 ms in the case of a conveyor belt application, and may be set to 1 second in the case of a mobile application. In the case of an inventory control application, the frame size may be differently set to 2 seconds, 4 seconds, and 8 seconds according to requests. A unit of the frame size may be not only a temporal unit but also be the number of readers that can access the frame, that is, the number of acceptable slots of the frame. Also, according to requests, the frame size may be differently set for each of a plurality of channels, or may be set based on other standards such as a physical position. For example, the frame size may be automatically adjusted by setting a synchronization signal sensing range so that adjacent readers, that is, the readers in the synchronization signal sensing range may use a same channel.

Second, the channel mediator senses a communication end of each of the readers, and transmits (17) an SS signal indicating a slot start in the frame. Also, according to a setting condition, a reader, which has competed with other readers by using the LBT technique to occupy a channel and has succeeded in the channel competition in a slot, may transmit the SS signal after communication with a tag is ended.

Third, when a channel is idle for a long enough time, the channel mediator transmits the FS signal to start the new frame or transmits the SS signal to start a next slot (18).

In the above procedures, a reader generally has to occupy a channel once in a frame, wait until a next frame starts, and then has to attempt a channel occupancy again. This may prevent channel occupancy starvation of some readers in a dense reader environment. However, when a reader has a high priority or an urgent request occurs, the frame size may be adjusted so as to enable a channel occupancy to be attempted several times in one frame.

In the above procedures, a wait time of the reader is related to the frame size. When the unit of the frame size is set as the temporal unit, a maximum wait time is twice as great as the frame size. If channel occupancy order information of each reader in a previous frame is used, the wait time may be reduced by half. This is in contrast with Table 1 showing that a maximum wait time is 9 times (21 seconds/2.4 seconds=9 times) as long as a mean wait time.

In the above procedures, in the case where a channel is randomly selected, and when there are more readers than can be accepted, the extra readers are allocated to some channels, and readers, which do not receive a service (a channel occupancy), are enabled to select a new channel after one frame is ended. By doing so, a plurality of readers may evenly share and use all available channels. Thus, after a channel selection is performed several times if required, each reader synchronizes itself with a synchronization signal in a corresponding channel by using the aforementioned methods so as to compete with other readers for a channel occupancy and to perform communication with a tag.

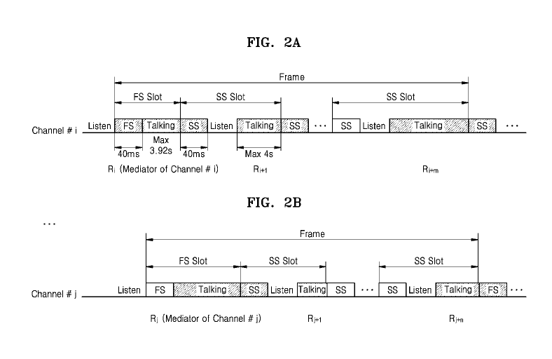

FIGS. 2A and 2B are diagrams of a frame structure when a plurality of readers, which share a specific channel, use a channel according to another embodiment of the present invention.

Referring to FIGS. 2A and 2B, an FS signal and an SS signal individually last for 40 ms. According to the technology standard, a reader may not occupy the specific channel for more than 4 s. Each of a plurality of channels has a channel mediator, and the readers selecting a channel compete with other readers in a slot to occupy a channel by using the LBT technique according to a synchronization signal based on the aforementioned methods. A reader, which has succeeded in the competition, communicates with a tag.

In a channel # i illustrated in FIG. 2A, a reader Rᵢ, which first occupies a channel by performing channel sensing, becomes a channel mediator of the channel #i, transmits the FS signal, and communicates with the tag. When the reader Rᵢ ends the communication, a first slot (an FS slot) is ended, and the reader Rᵢ transmits the SS signal. Other readers Rᵢ₊₁ through Rᵢ₊ₘ, which share the channel # i, sense a start of a second slot (an SS slot) by receiving the SS signal and compete with each other by using the LBT technique. The reader Rᵢ₊₁, which has succeeded in the competition, performs communication with a tag in the second slot. When the reader Rᵢ₊₁ ends the communication, the second slot is ended, and according to a setting condition, the reader Rᵢ or the reader Rᵢ₊₁ transmits an SS signal. After that, the rest of the other readers Rᵢ₊₂ through Rᵢ₊ₘ sense a start of a new slot by receiving the SS signal, and compete with each other by using the LBT technique, thereby sequentially communicating with a tag. When all acceptable readers of the channel # i end communication, one frame is ended, and then the reader Rᵢ, that is the channel mediator, transmits FS so that a new frame is started and the above operations are repeated.

Similar to the channel # i, in a channel # j illustrated in FIG. 2B, a reader Rⱼ, which first occupies a channel by performing channel sensing, becomes a channel mediator of the channel # j, transmits an FS signal, and communicates with a tag. Operations thereafter are the same as the operations of the readers in the channel # i, thus, a detailed description thereof will be omitted here.

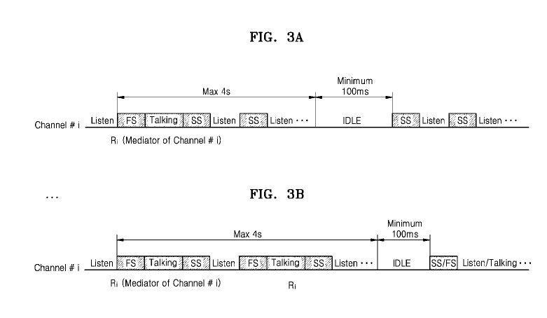

FIGS. 3A and 3B are diagrams of a frame structure when only a channel mediator, which first occupies a specific channel, uses a channel according to another embodiment of the present invention.

Referring to FIGS. 3A and 3B, in the case where only the channel mediator, which first occupies the specific channel, uses the channel, the channel mediator uses the channel for a maximum of 4 seconds according to the technology standard, and has to repeat the channel using procedure after waiting for approximately 100 ms.

In FIG. 3A, the channel mediator communicates with a tag in a first FS slot, and then repeatedly transmits an SS signal. After waiting for a minimum of 100 ms, the channel mediator repeatedly transmits the SS signal unless additional communication is required.

In FIG. 3B, the channel mediator communicates with a tag in a first FS slot, and then transmits an SS signal. When the channel mediator determines that there is no channel occupancy by other readers, the channel mediator transmits an FS signal in a next slot and re-communicates with a tag. This procedure is repeated for a maximum of 4 seconds. After waiting for a minimum of 100 ms, the channel mediator transmits an SS signal or an FS signal, and repeats the aforementioned operations.

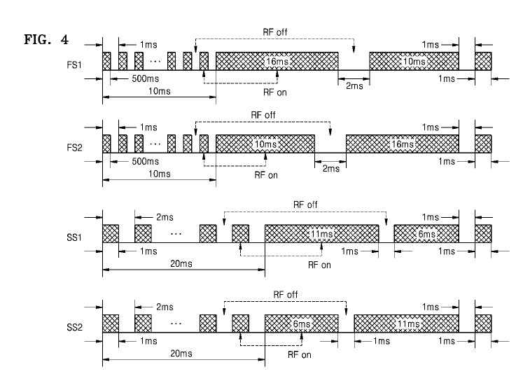

FIG. 4 is a diagram of a structure of a synchronization signal according to another embodiment of the present invention.

Referring to FIG. 4, an FS signal and an SS signal individually last for 40 ms, and are configured to have a specific RSSI pattern via ON and OFF of a radio frequency (RF) signal, such as FS1/FS2 signals and SS1/SS2 signals. For example, various synchronization signals such as the FS signal, the SS signal, and the like may be generated according to an ON/OFF period of the RF signal, and may be used in channel scheduling between each of a plurality of readers. In the current embodiment of the present invention, the FS signal and the SS signal are designed to include 1-bit information. However, if required, the present invention may generate a more elaborate signal to include information having more than 1 bit.

The synchronization signal is used not only to provide physical position (distance) information, an interference degree, or to synchronize each of the readers but also has information about a frame or channel status, for example, information about whether the frame has extra slots, information about a distribution of a mean channel occupancy time of the readers using a corresponding channel, information about when a channel occupancy is to be attempted, and the like. By doing so, the synchronization signal may efficiently control the plurality of readers. For example, when the FS1 and SS1 signals indicate that they can no longer accept new readers, the FS2 and SS2 signals indicate that they can accept new readers in a channel, so that a reader that selected the channel may determine whether to attempt to occupy the channel or whether to select a new channel. Thus, a chain-hopping phenomenon, which occurs when a newly entering reader attempts to occupy the channel, may be prevented. Also, the synchronization signal may enable a newly added reader to determine when to attempt to occupy the channel, such as at a frame start or a slot start. A channel occupancy order of a reader in one frame, that is a slot number, and the like, may be referred by a next frame operation.

A reader receiving the synchronization signal distinguishes the synchronization signal by using the LBT technique sensing an RSSI.

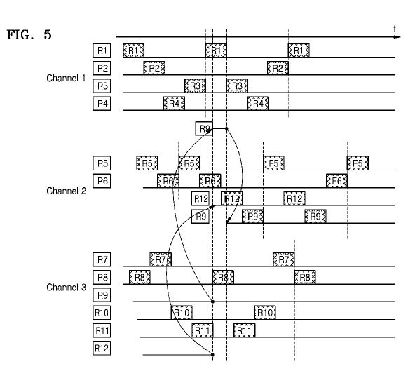

FIG. 5 is a diagram for illustrating channel scheduling according to another embodiment of the present invention.

Referring to FIG. 5, the current embodiment of the present invention is in a dense reader environment in which 12 readers competitively use 3 channels, and a frame size is enabled to accept 4 readers for each of the three channels.

Readers R1 through R4 select a channel 1, and sense the channel 1, so as to occupy the channel. First, the reader R1 that initially received a request becomes a channel mediator of the channel 1 and communicates with a tag for a specific period of time. After the communication is ended, the readers R2 through R4 compete with each other by using the LBT technique according to an SS signal. The reader R2 succeeds in the competition and communicates with a tag for a specific period of time in a second slot. Similarly, in a third slot, the reader R4 communicates with a tag, and in a fourth slot, the reader R3 communicates with a tag. When the communication of the reader R3 is ended, the R1, that is the channel mediator which has transmitted an FS signal, communicates with a tag in a first slot. After that, according to an SS signal, the reader R3 communicates with a tag in a second slot, the reader R4 communicates with a tag in a third slot, and the reader R2 communicates with a tag in a fourth slot. This procedure is repeated as long as each reader requests access.

The readers R5 and R6 select a channel 2, and sense the channel 2, so as to occupy the channel. First, the reader R5 that initially received a request becomes a channel mediator of the channel 2 and communicates with a tag for a specific period of time. After the communication is ended, the reader R6 communicates with a tag in a second slot, according to an SS signal. When the communication of the reader R6 is ended, the R5, that is the channel mediator which has transmitted an FS signal, communicates with a tag in a first slot. The reader R6 communicates with a tag in a second slot.

At a similar time to the above procedure, the readers R7 through R12 select a channel 3, and sense the channel 3, so as to occupy the channel. First, the reader R8 that initially received a request becomes a channel mediator of the channel 3 and communicates with a tag for a specific period of time. After the communication is ended, the readers R7, R9, R10, R11, and R12 compete with each other by using the LBT technique according to an SS signal. The reader R7 succeeds in the competition and communicates with a tag for a specific period of time in a second slot. Similarly, in a third slot, the reader R10 communicates with a tag, and in a fourth slot, the reader R11 communicates with a tag. When the communication of the reader R11 is ended, according to an FS signal, the R8, that is, the channel mediator, communicates with a tag in a first slot, the reader R11 communicates with a tag in a second slot, the reader R10 communicates with a tag in a third slot, and the reader R7 communicates with a tag in a fourth slot. This procedure is repeated as long as each reader requests access. Here, since the readers R9 and R12 do not receive a service (a channel occupancy) until a frame is ended, the reader R9 and the channel R12 respectively select the channel 1 and the channel 2, and sense a channel.

The reader R9 that selected the channel 1 senses an SS signal while sensing the channel, and immediately detects that the channel 1 cannot accept new readers any more, and thus the reader R9 selects the channel 2.

The readers R12 and R9, which selected the channel 2, sense an SS signal while sensing the channel, and immediately detect that the channel 2 can accept new readers, and thus the reader R12 communicates with a tag in a third slot, and the reader R9 communicates with a tag in a fourth slot. When the communication of the reader R9 is ended, according to an FS signal, the reader R5, that is, the channel mediator, communicates with a tag in a first slot, the reader R12 communicates with a tag in a second slot, the reader R9 communicates with a tag in a third slot, and the reader R6 communicates with a tag in a fourth slot. This procedure is repeated as long as each reader requests access.

As described above, after the reader R9 performs the channel selection procedure twice and the reader R12 performs the channel selection procedure once, the readers R1 through R4 communicate with a tag in the channel 1, the readers R5, R6, R12, and R9 communicate with a tag in the channel 2, and the readers R8, R7, R10, and R12 communicate with a tag in the channel 3.

Calculating the current embodiment of the present invention according to the conditions shown in Table 1, a maximum wait time is 4 seconds. This is in contrast with the conventional LBT technique in which the maximum wait time is 21 seconds, and the request requiring more than 4 seconds occupies more than 20% of a total of requests.

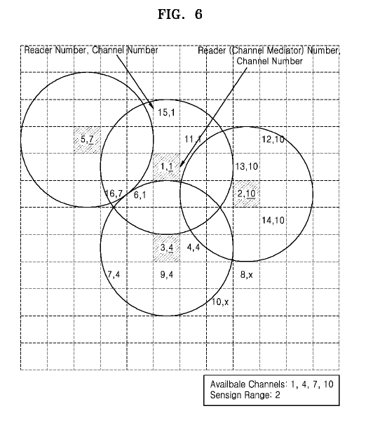

FIG. 6 is a diagram for describing a channel allocation method, according to an embodiment of the present invention.

The current embodiment of the present invention is a channel allocation case by which a plurality of adjacent readers use a same channel. In the current embodiment, available channels are channels # 1, # 4, # 7, and # 10, and a synchronization signal sensing range is 2. In other words, all readers within a range separated from a channel mediator by as much as 2 grids may use the same channel. A pair of numbers in each grid represents a reader number and a channel number.

Referring to FIG. 6, in the case where readers # 1 through # 16 sequentially operate, a channel mediator of the channel # 1 is the reader # 1, a channel mediator of the channel # 4 is the reader # 3, a channel mediator of the channel # 7 is the reader # 5, and a channel mediator of the channel # 10 is the reader # 2.

The rest readers share a physically adjacent channel, according to a level of an FS signal and an SS signal which have an RSSI pattern. Thus, the channel # 1 is shared by the readers # 1, # 6, # 11, and # 15, the channel # 4 is shared by the readers # 3, # 4, # 7, and # 9, the channel # 7 is shared by the readers # 5 and # 16, and the channel #10 is shared by the readers # 2, # 12, # 13, and # 14.

Since the synchronization signal sensing range is set to 2, the readers # 8 and # 10 may not find the channel mediator within a sensing range. Thus, in an actual application, the readers # 8 and # 10 share the channel # 4 that is closest.

When channel allocation is performed according to the current embodiment, adjacent readers share the same channel so that there is almost no interference within a same channel zone. Also, interference exists only with respect to other channel zones, instead of existing with respect to a specific reader, so that an affect caused by the interference may be relatively reduced. Zone planning for each channel is automatically performed. Here, the zone indicates a circle separated from the channel mediator by as much as 2 grids which represent the synchronization signal sensing range.

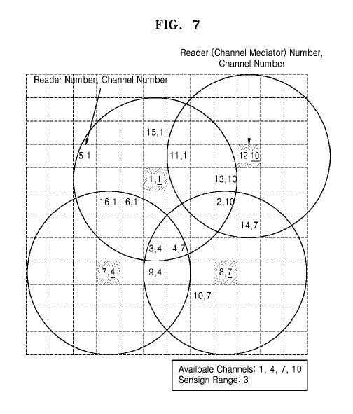

FIG. 7 is a diagram for describing a channel allocation method, according to another embodiment of the present invention.

The current embodiment of the present invention is a channel allocation case by which a plurality of adjacent readers use a same channel. In the current embodiment, available channels are channels # 1, # 4, # 7, and # 10, and a synchronization signal sensing range is 3. In other words, all readers within a range separated from a channel mediator by as much as 3 grids may use the same channel. A pair of numbers in each grid represents a reader number and a channel number.

Referring to FIG. 7, in the case where readers # 1 through # 16 sequentially operate, a channel mediator of the channel # 1 is the reader # 1, a channel mediator of the channel # 4 is the reader # 7, a channel mediator of the channel # 7 is the reader # 8, and a channel mediator of the channel # 10 is the reader # 12.

The rest of the readers share a physically adjacent channel, according to a level of an FS signal and an SS signal which have an RSSI pattern. Thus, the channel # 1 is shared by the readers # 1, # 5, # 6, # 11, #15, and # 16, the channel # 4 is shared by the readers # 3, # 7, and # 9, the channel # 7 is shared by the readers # 4, # 8, # 10, and # 14, and the channel # 10 is shared by the readers # 2, # 12, and # 13.

As illustrated in the current embodiment, adjacent readers share the same channel so that there is almost no interference within a same channel zone. Also, interference exists only with respect to other channel zones, instead of existing with respect to a specific reader, so that an affect caused by the interference may be relatively reduced. In the current embodiment, zone planning for each channel is automatically performed. Here, the zone indicates a circle separated from the channel mediator by as much as 3 grids which represent the synchronization signal sensing range.

As described above, the channel zone is formed, and readers in a specific channel zone share the same channel, so that only one reader operates in each channel zone at a specific time. Therefore, there is almost no interference within the same channel zone, and interference exists only with respect to other channel zones, instead of existing with respect to a specific reader, so that an affect caused by the interference may be relatively reduced and received power increases, compared to the conventional LBT technique.

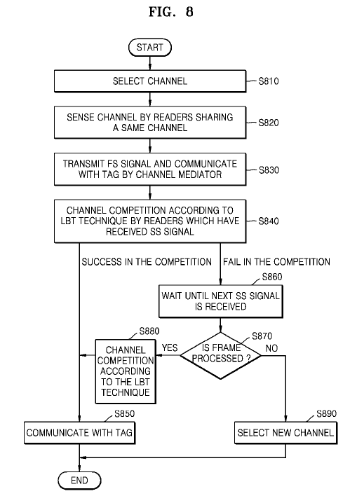

FIG. 8 is a flowchart of a media access method performed by a reader in a dense reader environment, according to another embodiment of the present invention.

Referring to FIG. 8, the media access method in the dense reader environment according to the current embodiment of the present invention divides an air time, of each of a plurality of channels shared by a plurality of readers, into a plurality of slots, occupies a channel in each of the plurality of slots by performing channel sensing, and enables the plurality of slots to form a frame having a predetermined size. Detailed operations performed in each procedure have been described above, and thus, will be omitted here.

Each of the readers selects a channel from among a plurality of available channels so as to communicate with a tag (operation S810). A channel selection method may be set according to various standards including the above described channel selection methods.

The plurality of readers sharing each of the channels sense a channel (operation S820).

A reader first attempting to occupy a channel becomes a channel mediator and transmits an FS signal to start a frame and to communicate with a tag (operation S830).

When the communication of the channel mediator is ended, other readers, which receive an SS signal indicating a start of a new slot, compete with each other by using the LBT technique to occupy the channel (operation S840).

A reader that succeeds in the channel competition communicates with a tag (operation S850).

A reader that fails in the channel competition waits until a next SS signal is received (operation S860).

Whether the frame is processed or ended is determined (operation S870).

When the frame is not ended and the next SS signal is received, the reader that failed competes with other readers to occupy the channel by using the LBT technique (operation S880). The reader that succeeded in the channel competition communicates with a tag (operation S850).

A reader, which is not assigned a slot in the frame since the frame is ended, selects a new channel (operation S890).

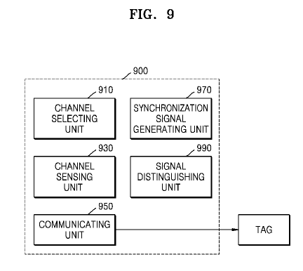

FIG. 9 is a block diagram of an internal structure of a reader 900 that operates based on the slotted-LBT technique according to another embodiment of the present invention. Detailed descriptions about operations of each of a plurality of components, which have already been given above, will be omitted here.

Referring to FIG. 9, the reader 900 includes a channel selecting unit 910, a channel sensing unit 930, a communicating unit 950, a synchronization signal generating unit 970, and a signal distinguishing unit 990.

The channel selecting unit 910 selects a channel according to a tag data access request. A plurality of available channels may be configured by a preformed channel zone so that adjacent readers may use a same channel. Also, the channel selecting unit 910 selects a new channel according to a result of sensing performed by the channel sensing unit 930.

The channel sensing unit 930 senses a channel in a unit of a slot by using the LBT technique. An air time is divided into a plurality of slots in each channel, and the plurality of slots form a frame.

The communicating unit 950 communicates with a tag according to a predetermined procedure, based on the result of sensing.

The synchronization signal generating unit 970 generates a synchronization signal having a specific pattern via ON/OFF of an RF signal. The synchronization signal generating unit 970 generates an FS signal and an SS signal, which have the specific pattern according to an ON/OFF period of the RF signal and an ON/OFF length of the RF signal, and inserts various information into the synchronization signal.

The signal distinguishing unit 990 detects a specific pattern of a signal received from another reader, according to an RSSI value, and distinguishes the synchronization signal. The signal distinguishing unit 990 distinguishes the FS signal from the SS signal, and detects information indicated by each of the FS signal and the SS signal.

Table 2 shows a comparison between the conventional LBT technique and the slotted-LBT technique according to the present invention, and the comparison is performed with respect to a minimum value, a maximum value, a mean value, a variance value, a standard deviation value, and a coefficient of variation value which are related to a channel obtainment time. Each of a plurality of readers has an 800 ms channel occupancy time, and a ratio of the number of available channels to the number of readers is set to 1:4.

TABLE 2
(a unit: second)

| Algo- | Mini- | Maxi- | | | Standard | Coefficient |
|---|---|---|---|---|---|---|
| rithms | mum | mum | Mean | Variance | deviation | of variation |
| LBT | 0.015 | 21.47 | 2.45 | 5.53 | 2.35 | 96% |
| Slotted- | 0.8 | 4 | 2.4 | 0.85 | 0.92 | 38% |
| LBT | | | | | | |

As shown in Table 2, according to a function analysis result, it is possible to understand that a channel scheduling algorithm based on the slotted-LBT technique according to the present invention reduces variation of a wait time from 96% to 38%, compared to the conventional LBT technique algorithm.

Table 3 shows a comparison between a conventional frequency hopping (FH) technique and LBT technique, and the slotted-LBT technique according to the present invention.

TABLE 3
Comparison of media access method

| Comparison | technique | | |
|---|---|---|---|
| standards | FH | LBT | Slotted-LBT |
| The number | The number of | The number of | No particular limitation |
| of acceptable | acceptable readers | acceptable readers | |
| readers | is determined by a | is determined by | |
| | channel occupancy | the number of | |
| | time and the | channels. | |
| | number of | | |
| | channels. | | |
| Wait time | No wait time but | Large variation: | Small variation: |
| for channel | a success rate | A difference | A wait time is |
| occupancy | is extremely low. | between a | determined by a frame |
| | | maximum wait time | size, and distribution is |
| | | and a minimum | very low compared to |
| | | wait time is great. | the conventional LBT |
| | | | technique. |
| Same channel | High | Low | Very low: Channel |
| collision | | | occupancy order |
| | | | information of each |
| | | | reader in a previous |
| | | | frame is used, |
| | | | thus, same channel |
| | | | collision is prevented. |
| Interference from | High | High | Low: Zone planning |
| same/adjacent | | | for each channel |
| channels | | | reduces an affect due |
| | | | to interference. |
| RSSI sensing | Not applicable | Normal | High: There is almost |
| ability | | | no interference within |
| | | | channel zone. |
| Control for each | Difficult | Normal: | Easy: Channels are |
| channel | | A separate | divided according to |
| | | centralized control | applications and |
| | | device is required. | requests by using a |
| | | | channel mediator (a |
| | | | reader) so that control |
| | | | for each channel is |
| | | | possible. |
| Zone planning for | Not applicable | Normal: | Easy: Operation is |
| each channel | | A separate | possible via a |
| | | centralized control | distribution manner, |
| | | device is required. | without a separate |
| | | | device. |
| Compatibility with | Available with FH | Available with LBT | Available with LBT and |
| conventional | only | only | Slotted-LBT |
| technique | | | |

As described above, the slotted-LBT technique may be constantly applied to a conventional LBT-based RFID system, without changing an air protocol, without adding a separate device or without a separate frequency source allocation, may be efficiently applied to a case where a plurality of readers are disposed and operated, such as distribution stores, distribution centers, and the like. By doing so, the slotted-LBT technique may greatly contribute to introducing and spreading the RFID technology in the industry.

The present invention can be applied to various RFID applications including distribution, management, and the like. If a reader supports the LBT technique based on an RSSI sensing function, the reader can be constantly used without changing the air protocol, without adding the separate device or without the separate frequency source allocation.

Also, the present invention can be applied not only to the dense reader environment but also to a multi-reader environment that is an environment in which the number of readers is relatively small, can be applied to a fixed reader environment, to a movable (portable) reader environment or to an environment including both fixed readers and movable readers, and even can be applied to an environment in which readers supporting only the convention LBT technique and readers supporting the slotted-LBT technique exist together.

The present invention provides a scheme that can implement a media access algorithm based on the slotted-LBT so as to appropriately control a reader according to the various RFID applications.

Unlike a conventional global method in which a reader competes with all readers in a specific zone to occupy a channel, the present invention enables channel competition to be locally performed between each of a plurality of readers which are limited to a specific channel so that a wait time (variation of a channel obtainment time) for a service is reduced, a wait time distribution for servicing each request becomes constant so as to provide a stable service, and the number of acceptable readers is increased.

The present invention easily performs channel zone planning by which adjacent readers can share a same channel, so that there is almost no interference within a same channel zone. Also, interference exists only with respect to other channel zones, instead of existing with respect to a specific reader, so that an affect caused by the interference may be relatively reduced.

The present invention can adjust a reader output level for each channel to reduce the interference between each of the readers, and simultaneously can increase a re-use rate of channels.

According to the present invention, the channels can be easily divided and used according to requirements of the various RFID applications. Also, in the case where different requests are received from the various RFID applications, the present invention can easily provide additional functions such as grading a priority according to each of the different requests of the various RFID applications, and the like, so that the different requests can be processed according to services and grades of the various RFID applications.

The invention can also be embodied as computer readable codes on a computer readable recording medium. The computer readable recording medium is any data storage device that can store programs or data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers of ordinary skill in the art to which the present invention pertains.

While this invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A media access method performed by a reader in a dense reader environment, the media access method comprising:
dividing an air time of a channel, which is shared by a plurality of readers, into a plurality of slots; and
occupying the channel after performing channel sensing in each of the plurality of slots,
wherein the plurality of slots form a frame having a predetermined size.

2. The media access method of claim 1, further comprising:
transmitting an FS (frame synchronization) signal and occupying a channel in a first slot of the frame, wherein the transmitting and occupying are performed by a reader which is from among the plurality of readers that selected a same channel, which first senses that the channel is idle, and which becomes a channel mediator of the channel; and
occupying the channel sequentially from a second slot, wherein the occupying is performed by the rest of the plurality of readers which receive an SS (slot synchronization) signal and which perform the channel sensing.

3. The media access method of claim 2, further comprising:
selecting a new channel having extra slots, wherein the selecting is performed by a reader which is from among the plurality of readers and which fails to occupy the channel in a slot in the frame; and
receiving an SS signal in the new channel and occupying the new channel by performing the channel sensing.

4. The media access method of claim 2, wherein the FS signal and the SS signal have a specific pattern via ON/OFF of an RF (radio frequency) signal, and the plurality of readers detect the specific pattern based on an RSSI (received signal strength indication) value so as to distinguish the FS signal from the SS signal.

5. The media access method of claim 4, wherein the FS signal and the SS signal comprise information having 1 bit or more.

6. The media access method of claim 2, wherein the SS signal is transmitted by the channel mediator or a reader which finishes occupying the channel.

7. The media access method of claim 1, wherein the predetermined size of the frame is determined based on at least one of a maximum acceptable wait time of a reader, the number of acceptable readers in a channel, and a synchronization signal sensing range.

8. A media access method performed by a reader in a dense reader environment, the media access method comprising:
selecting a channel according to a tag data access request;
dividing an air time into a plurality of slots in the selected channel, and sensing a channel in a unit of a slot; and
communicating with a tag according to a predetermined procedure, based on a result of the sensing.

9. The media access method of claim 8, wherein the communicating comprises, when the selected channel is determined to be idle for a predetermined period of time, transmitting an FS signal indicating a start of a frame formed of a plurality of slots and occupying the channel in one of the plurality of slots, wherein the transmitting is performed by a reader that becomes a channel mediator of the channel.

10. The media access method of claim 8, wherein the communicating comprises, when an RSSI value of the selected channel is between an upper threshold value and a lower threshold value which are preset, selecting a new channel and communicating with a tag in the new channel by performing channel sensing in a unit of a slot.

11. The media access method of claim 8, wherein the communicating comprises:
determining whether to select a new channel when a QoS (quality of service) of the selected channel does not satisfy a predetermined QoS; and
communicating with a tag in the new channel by performing the channel sensing in the unit of the slot.

12. The media access method of claim 8, wherein the communicating comprises:
waiting to sense an SS signal when the FS signal indicating the start of the frame formed of the plurality of slots in the selected channel is sensed; and
when the SS signal is sensed, competing with other readers in the selected channel in a slot after performing channel sensing, so as to occupy the selected channel.

13. The media access method of claim 8, wherein the communicating comprises, when the SS signal is sensed in the selected channel, competing with other readers in the selected channel in a slot by performing the channel sensing so as to occupy the selected channel.

14. The media access method of claim 9, further comprising, when the communication with the tag is ended, transmitting a new FS signal or an SS signal which enables other readers to occupy the channel in a next slot.

15. The media access method of claim 10, wherein the performing of the channel sensing comprises sensing a channel in each of the plurality of slots by using an LBT (listen before talking) technique.

16. The media access method of claim 10, wherein the selecting of the new channel comprises selecting a channel allocated to a section to which the reader belongs, and which is from among a plurality of sections formed by dividing a zone, where a plurality of readers exist, into the plurality of sections having a predetermined size.

17. A media access method performed by a reader in a dense reader environment, the media access method comprising:
dividing a zone, where a plurality of readers exist, into a plurality of sections;
selecting a channel allocated to a section to which a reader belongs, from among the plurality of sections, and communicating with a tag after performing channel sensing; and
when a reader from among the plurality of readers does not belong to any one of the plurality of sections, selecting a channel allocated to a section most adjacent to the reader and communicating with a tag after performing channel sensing.

18. The media access method of claim 17, wherein the selecting of the channel comprises, when the reader exists in a sections overlapping zone, selecting an adjacent channel according to a synchronization signal level from each of a plurality of channel mediating readers.

19. The media access method of claim 17, wherein a size of each of the plurality of sections is determined based on a synchronization signal sensing range which is preset distance from each of a plurality of channel mediating readers.

20. A reader that accesses media in a dense reader environment, the reader comprising:
a channel selecting unit selecting a channel according to a tag data access request;
a channel sensing unit dividing an air time into a plurality of slots and sensing a channel in a unit of a slot in the selected channel in which the plurality of slots form a frame; and
a communicating unit communicating with a tag according to a predetermined procedure, based on a result of the sensing.

21. The reader of claim 20, further comprising:
a synchronization signal generating unit generating a synchronization signal which has a specific pattern via ON/OFF of an RF signal; and
a signal distinguishing unit distinguishing a synchronization signal by detecting a specific pattern of a signal received from other readers, according to an RSSI value.
